(19) United States
(12) Patent Application Publication
(10) Pub. No.: US 2008/0298181 A1
(43) Pub. Date: Dec. 4, 2008

(54) OPTICAL DISC APPARATUS AND OPTICAL DISC APPARATUS CONTROL METHOD

(75) Inventors: Masashi Ueno, Tokyo (JP); Teruyoshi Kogure, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/128,208

(22) Filed: May 28, 2008

(30) Foreign Application Priority Data
May 31, 2007 (JP) 2007-145273

(51) Int. Cl. G11B 7/00

(52) U.S. Cl. 369/44.14

(57) ABSTRACT

According to one embodiment, a control method, includes moving a pickup head to an adjustment position adjusting the quantity of adjustment of focus balance measuring the amplitude of an RF signal in the adjustment position adjusting the focus balance adjustment quantity and measuring the RG signal amplitude a plurality of times estimating the focus balance adjustment quantity at which the RF signal amplitude is maximized from the measured focus balance adjustment quantities and RF signal amplitude moving the pickup head to a different adjustment position estimating the focus balance adjustment quantity at which the RF signal amplitude is maximized in the different adjustment position by adjusting the focus balance adjustment quantity and measuring the RF signal amplitude a plurality of times and adjusting the focus balance adjustment quantity to the focus balance adjustment quantity estimated in the different adjustment position.

### CROSS-REFERENCE TO RELATED APPLICATIONS

This application is based upon and claims the benefit of priority from Japanese Patent Application No. 2007-145273, filed May 31, 2007, the entire contents of which are incorporated herein by reference.

### BACKGROUND

1. Field

One embodiment of the invention relates to an optical disc apparatus in which the quantity of adjustment of focus balance of a loaded optical disc is determined in two or more positions in the direction of its radius and an optical disc apparatus control method.

2. Description of the Related Art

In recent years, the high density version of optical discs has been accelerated and standards for the HD DVD and Blu-ray disc have been set up. In high-density optical discs, such as the HD DVD and Blu-ray disc, the margin for focus offset is small. Thus, the adjustment of focus balance is required in order to ensure high reproduction/recording performance.

JP-A No. 2000-306247 (KOKAI) discloses a technique to detect the optimum quantity of adjustment of focus balance using a testing optical disc in the process of adjustment prior to shipment.

With discs, such as the HD DVD and Blu-ray disc, in which the margin for focusing offset is small, even if the focus balance has been adjusted prior to shipment, it is impossible to ensure high reproduction/recording performance for the entire area of an optical disc.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary system block diagram of an optical disc apparatus according to an embodiment of the present invention;

FIG. 2 is an exemplary diagram showing the relationship between the RF amplitude and the byte error rate (BER) as an index of reproduction performance when the focus balance is varied;

FIG. 3 is an exemplary diagram for use in explanation of focus balance adjustment positions set up in the direction of the radius of an optical disc;

FIG. 4 is an exemplary block diagram of the configuration for determining the optimum focus balance adjustment quantities from the RF amplitude according to the present invention;

FIG. 5 is an exemplary diagram showing RF amplitude duty ratio versus light beam irradiated position;

FIG. 6 is an exemplary flowchart for detecting focus balance adjustment values;

FIG. 7 is an exemplary flowchart for detecting focus balance adjustment values;

FIG. 8 is an exemplary block diagram of the configuration for determining focus balance adjustment quantities while recording data on an unrecorded disc of recordable type according to the present invention;

FIG. 9 is an exemplary diagram for use in explanation of data for focus balance adjustment which is recorded in the power calibration area (PCA) of the optical disc;

FIG. 10 is an exemplary flowchart for determining focus balance adjustment quantities while recording data;

FIG. 11 is an exemplary diagram showing the positions of the pickup head at the times of suspension of recording, movement to a measurement position, and resumption of recording; and

FIG. 12 is an exemplary block diagram of the configuration for adjusting the focus balance at the time of reproduction of a recordable disc.

### DETAILED DESCRIPTION

Various embodiments according to the invention will be described hereinafter with reference to the accompanying drawings. In general, according to one embodiment of the invention, an optical disc apparatus having a function of adjusting focus balance, comprising: a pickup head configured to irradiate a light beam onto an optical disc and receive the light beam reflected from the optical disc to output a detected signal a movement unit configured to move the pickup head to two or more adjustment positions an amplitude measurement unit configured to measure the amplitude of an RF signal in the detected signal from the pickup head an adjustment signal output unit configured to output an adjustment signal a focus balance adjustment unit configured to adjust the quantity of focus balance adjustment according to the adjustment signal an adjustment signal changing unit configured to instruct the adjustment signal output unit a plurality of times to change the adjustment signal in order to measure the RF signal amplitude for each of a plurality of focus balance quantities in each of the adjustment positions a maximum RF amplitude adjustment quantity estimation unit configured to estimate a focus balance adjustment quantity at which the RF signal amplitude is maximized from the focus balance adjustment quantities and the RF signal amplitude measured by the amplitude measurement unit a storage unit configured to store the focus balance adjustment quantities at which the RF signal amplitude is maximized each estimated in a respective one of the adjustment positions and an adjustment quantity instruction unit configured to, at the time of playback/recording of the optical disc, instruct the adjustment signal output unit to output an adjustment signal for each of the focus balance adjustment quantities stored in the storage unit.

An embodiment of the present invention will be described hereinafter with reference to the accompanying drawings.

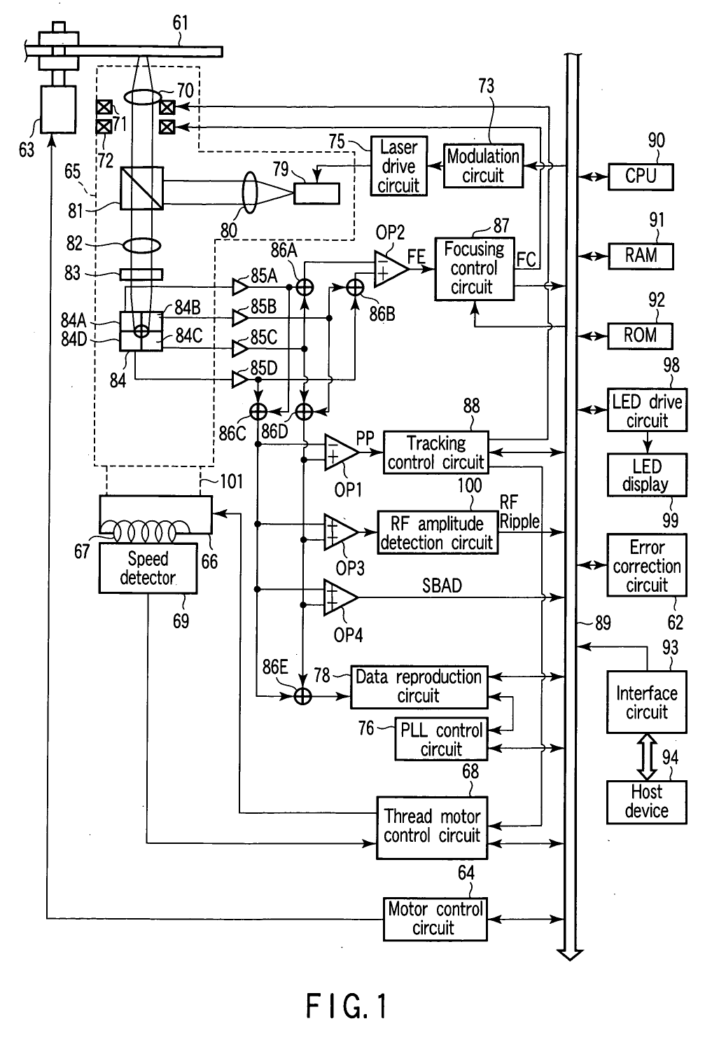

FIG. 1 is a system block diagram of an optical disc apparatus according to an embodiment of the present invention.

An optical disc 61 loaded into an optical disc apparatus 11 is a user data recordable optical disc or a read-only optical disc. In this embodiment, the optical disc is described as a recordable optical disc of multilayer structure. Optical discs having two or more recording layers include DVD-Rs but are not limited to them.

Each of the information recording layers of the optical disc 61 is formed with a land track and a groove track in the form of a spiral. The optical disc 61 is rotated by a spindle motor 63.

Information is recorded on or reproduced from the optical disc 61 by means of an optical pickup head 65 (indicated enclosed by broken lines in the left portion of FIG. 1). The optical pickup head 65 is coupled to a thread motor 66 by a coupler 101 including gears. The thread motor 66 is controlled by a thread motor control circuit 68.

A speed detector 69 set below the thread motor 66, which detects the speed at which the optical pickup moves, is connected to the thread motor control circuit 68. A speed signal of the optical pickup head 65 detected by the speed detector 69 is sent to the thread motor control circuit 68. The stationary portion of the thread motor 66 is provided with a permanent magnet not shown. Excitation of a drive coil 67 by the thread motor control circuit 68 allows the optical pickup head 65 to move in the direction of radius of the optical disc 61.

The optical pickup head 65 is provided with an objective lens 70 supported by a wire or leaf spring by way of example. The objective lens 70 can be moved in the tracking direction (the direction of the track of the optical disc) by a tracking drive coil 71. Also, the objective lens 70 can be moved in the tracking direction and in the focusing direction (the direction of the optical axis of the lens) by a focusing drive coil 72.

A modulation circuit 73 receives, in recording information on the optical disc 61, an information signal to be recorded through an interface circuit 93 and a bus 89 from a host device 94 and modulates it in a modulation form (e.g., 8-16 modulation) which conforms to the standards of the optical disc. At the time information is recorded on the optical disc 61 (at the time marks are formed), a laser drive circuit 75 supplies a semiconductor laser diode unit 79 with a write signal on the basis of a modulated signal from the modulation circuit 73. Also, the laser drive circuit 75 supplies the semiconductor laser diode unit 79 with a reading signal smaller than the write signal at the time information is reproduced.

The semiconductor laser diode unit 79 generates laser light in response to a signal applied from the laser drive circuit 75. The laser light from the semiconductor laser diode unit 79 is directed onto the optical disc 61 through a collimator lens 80, a half prism 81, and the objective lens 70. The light is reflected from the optical disc 61 through the objective lens 70, the half prism 81, a condenser lens 82, and a cylindrical lens 83 onto a photosensor 84.

The semiconductor laser diode unit 79 comprises three laser diodes to emit three beams of laser light: one for CD (infrared: 780 nm in wavelength), one for DVD (red: 650 nm), and one for HD DVD (violet: 405 nm). These semiconductor laser diodes may be housed in the same can package. Alternatively, they may be housed respectively in three independent can packages and arranged separately on the base of the optical pickup head 65. The optical system has its configuration and arrangement changed according to the configuration of semiconductor lasers.

Of the components that make up the optical system, the objective lens is designed so as to allow the laser light for HD DVD to be properly focused on the disc. The optical system includes aberration correction elements (a diffraction element, a phase correction element, etc.) which suppress aberration that occurs when the laser light for DVD and CD is used and numerical aperture limiting elements (a liquid crystal shutter, a diffraction element, etc.) for limiting the numerical aperture for the objective lens when the laser light for CD is used.

The photosensor 84 is split into, for example, four quadrants and is therefore made up of four sensor cells 84A, 84B, 84C, and 84D. The output signals of the split sensor cells 84A through 84D are applied to current-to-voltage conversion amplifiers 85A through 85D, respectively. The output signals of the amplifiers 85A and 85C are applied to an adder 86A. The output signals of the amplifiers 85D and 85B are applied to an adder 86B. The output signals of the amplifiers 85A and 85D are applied to an adder 86B. The output signals of the amplifiers 85A and 85D are applied to an adder 86C. The output signals of the amplifiers 85B and 85C are applied to an adder 86D. The output signals of the adders 86A and 86B are applied to a differential amplifier OP2 and the output signals of the adders 86C and 86D are applied to a differential amplifier OP1.

The differential amplifier OP2 generates a focus error signal FE from the difference between the outputs of the adders 86A and 86B. The focus error signal FE is applied to a focusing control circuit 87, the output signal FC of which is applied to the focusing drive coil 72. Controlled by the output signal FC of the focusing control circuit 87, the laser light is always brought to focus on the recording surface of the optical disc 61. The focusing control circuit 87 has a function of measuring the amplitude of the focus error signal FE and outputs the measured values to a CPU 90 over the bus 89.

The differential amplifier OP1 produces a push-pull signal from the difference between the outputs of the adders 86C and 86D. The push-pull signal PP is applied to a tracking control circuit 88, which produces a tracking drive signal. The tracking drive signal output from the tracking control circuit 88 is applied to the tracking drive coil 71 to drive the objective lens 70 in the direction normal to its optical axis. Controlled by the tracking drive signal, the laser light is directed onto a given spot on the recording surface of the optical disc 61. A tracking error signal TE used in the tracking control circuit 88 is also applied to the tread motor control circuit 68.

When the focusing control and the tracking control are performed in the above manner, the sum signal of the output signals of the sensor cells 84A through 84E of the photosensor 84, namely, the output signal RF of an adder 86E, which adds the output signals of the adders 86C and 86D together, is allowed to contain a signal faithful to recorded information to be obtained. The output signal RF is applied to a data reproduction circuit 78.

An operational amplifier OP3 adds the output signals of the adders 86C and 86D together and performs high-pass filter processing on the sum signal to produce an output signal (RF). The output signal of the operational amplifier OP3 is applied to an RF amplitude detection circuit 100 to generate a signal (RF ripple) whose level is proportional to the amplitude of the RF signal. The RF amplitude detection circuit 100 detects the maximum and minimum values of the RF signal and determines the difference between them.

An operational amplifier OP4 adds the output signals of the adders 86C and 86D and performs low-pass filter processing on the sum signal (the sum signal of the outputs of the split sensor cells 84A to 84D). By detecting the intensity of the sum signal subjected to low-pass filter processing, an SBAD (sub-beam addition) signal is generated.

The data reproduction circuit 78 in the lower portion of FIG. 1 reproduces recorded data on the basis of a clock signal from a PLL circuit 76. The data reproduction circuit 78 has a function of measuring the amplitude of the signal RF and outputs the measured values to the CPU 90 over the bus 89.

The thread motor control circuit 68 controls the thread motor 66 to move the body of the optical pickup head 65 so that the objective lens 70 is located in the vicinity of the center of the head.

The motor control circuit 64, the thread motor control circuit 68, the modulation circuit 73, the laser drive circuit 75, the PLL circuit 76, the data reproduction circuit 78, the focusing control circuit 87 and the tracking control circuit 88 can be integrated into a single LSI chip. These circuits are controlled by the CPU 90 over the bus 89. The CPU 90 controls the entire disc recording/reproduction apparatus in accordance with operation commands applied from the host device 94 through the interface circuit 93. Using a RAM 91 as the working area, the CPU 90 performs predetermined control operations in accordance with a program recorded in a ROM 92 and containing the inventive processing.

The adjustment of focus balance in this disc drive will be described hereinafter.

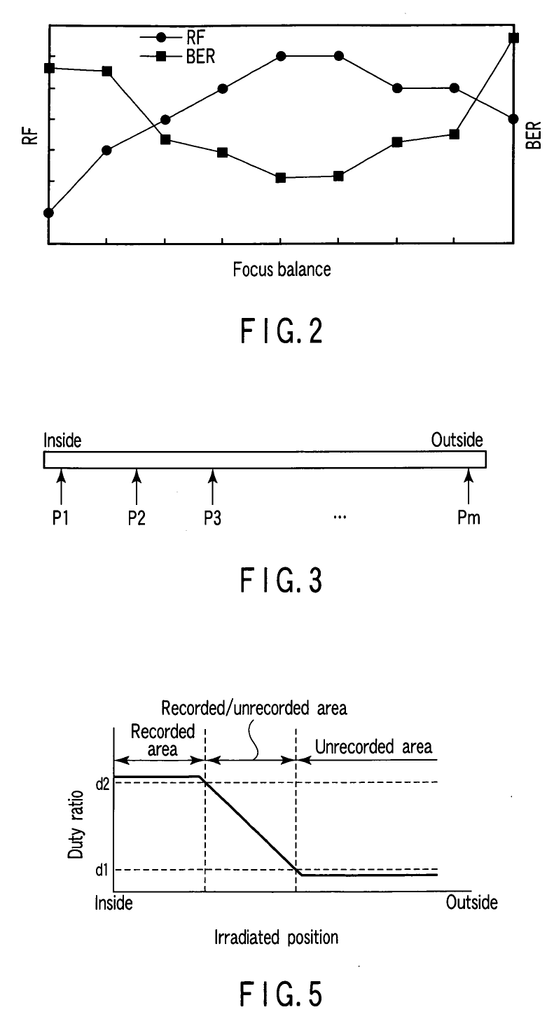

FIG. 2 shows the relationship between the RF amplitude and the byte error rate (BER) as an index of reproduction performance when the focus balance is varied. From FIG. 2, it can be seen that the RF amplitude and the error rate are correlated with each other and the error rate can be minimized by fitting focus balance to the point at which the RF amplitude is maximized. Thus, the present device measures the RF amplitude while varying the focus balance and determines the optimum focus balance from the measured values of RF amplitude.

Even with an optical disc which is small in focus offset margin as is the case with HD DVD, in order to ensure high reproduction/recording performance over all areas, two or more focus balance adjustment positions are set up in the direction of radius as shown in FIG. 3 and the optimum focus balance is determined for each radial position.

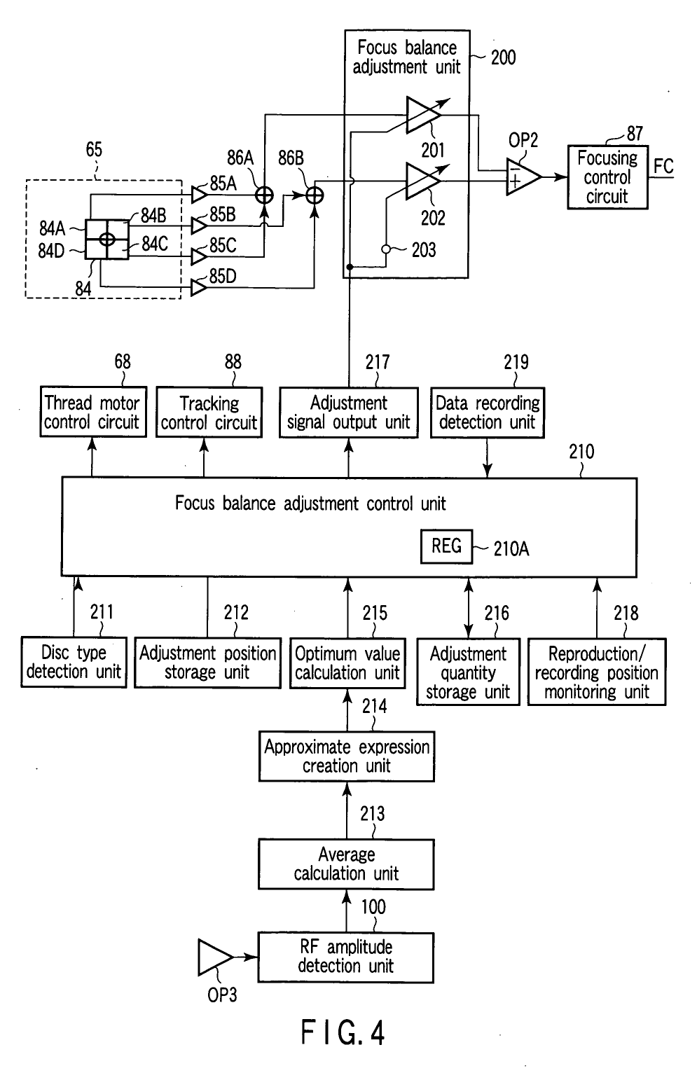

Next, the configuration for measuring the RF amplitude and determining the optimum quantity of focus balance adjustment from the measured RF amplitude values will be described with reference to FIG. 4.

As shown in FIG. 4, this configuration includes a disc type detection unit 211, an adjustment position storage unit 212, an average calculation unit 213, an approximate expression creation unit 214, an optimum value calculation unit 215, an adjustment quantity storage unit 216, an adjustment signal output unit 217, a reproduction/recording position monitoring unit 218, and a data recording detection unit 219.

The disc type detection unit 211 detects the type of a disc from information recorded in its read-in area. There are various types of optical disc, such as read-only (HD DVD-ROM), write-once (HD DVD-R), and rewritable (HD DVD-RW and HD DVD-RAM).

The adjustment position storage unit 212 is stored with information about positions in which the focus balance of the optical disc is adjusted. The average calculation unit 213 calculates the average value of RF amplitude from the detected signals output from the RF amplitude detection circuit 100 while the optical disc makes one rotation.

The approximate expression creation unit 214 creates an approximate expression indicating the RF amplitude versus focus balance adjustment quantity relationship from the focus balance adjustment quantities and the measured RF amplitude values using the method of least squares. The optimum value calculation unit 215 calculates the focus balance adjustment quantity at which the RF signal amplitude is maximized from the approximate expression created by the approximate expression creation unit 214.

The adjustment quantity storage unit 216 stores the focus balance adjustment quantities calculated by the optimum value calculation unit 215 for the adjustment positions stored in the adjustment quantity storage unit 216. The adjustment signal output unit 217 outputs an adjustment signal to the focus balance adjustment unit 200 as instructed by the focus balance adjustment control unit 210.

The focus balance adjustment unit 200 has amplifiers 201 and 202 and an inverter 203. The amplifier 201 amplifies the sum signal of the outputs of the photosensor cells 84A and 84C according to the adjustment signal. The amplifier 202 amplifies the sum signal of the outputs of the sensor cells 84D and 84B according to the output signal of the inverter 203 which is opposite in polarity to the adjustment signal.

The reproduction/recording position monitoring unit 218 monitors the reproduction/recording positions during reproduction or recording and, when each of the positions stored in the adjustment position storage unit 212 is reached, notifies the focus balance adjustment control unit 210 to that effect. The focus balance adjustment control unit 210 reads the focus balance adjustment quantity corresponding to that position from the adjustment quantity storage unit 216 and then instructs the adjustment signal output unit 217 to output an adjustment signal corresponding to the read focus balance adjustment quantity.

The data recording detection unit 219 decides which of the recorded area and the unrecorded area the light beam is being directed onto. For this decision use is made of a signal indicating the presence or absence of the RF signal. The duty ratio of the RF signal is measured while the disc makes one rotation with the tracking servo by the tracking control circuit 88 turned off. In FIG. 5, the duty ratio of the RF amplitude is plotted against the light beam irradiated position. As shown in FIG. 5, it can be decided that, if the duty ratio is more than a threshold d2, the beam is being directed onto the recorded area and, if the duty ratio is less than a threshold d2, it is being directed onto the unrecorded area. When the duty ratio is between d1 and d2, it can be decided that the light beam is moving between the recorded and unrecorded areas.

Since the tracking servo is turned off, the beam irradiated position in the direction of radius undulates from side to side due to the eccentricity of the optical disc. As a result, when the irradiated position is in the boundary between the recorded and unrecorded areas, these areas will be alternately irradiated with the light beam. Naturally, the closer to the recorded area the irradiated position is, the greater the duty ratio becomes, since the recorded area is irradiated with the light beam. Therefore, whether the irradiated position is on the recorded area or the unrecorded area can be known from the duty ratio.

In addition, in the state in which the tracking servo is turned off, the RF signal is disturbed and tends to increase in amplitude.

The focus balance adjustment control unit 210 controls the detection of the focus balance adjustment quantities and sets the focus balance adjustment quantities. A register 201A stores information about the detection position at the time of detection of the focus balance adjustment quantity.

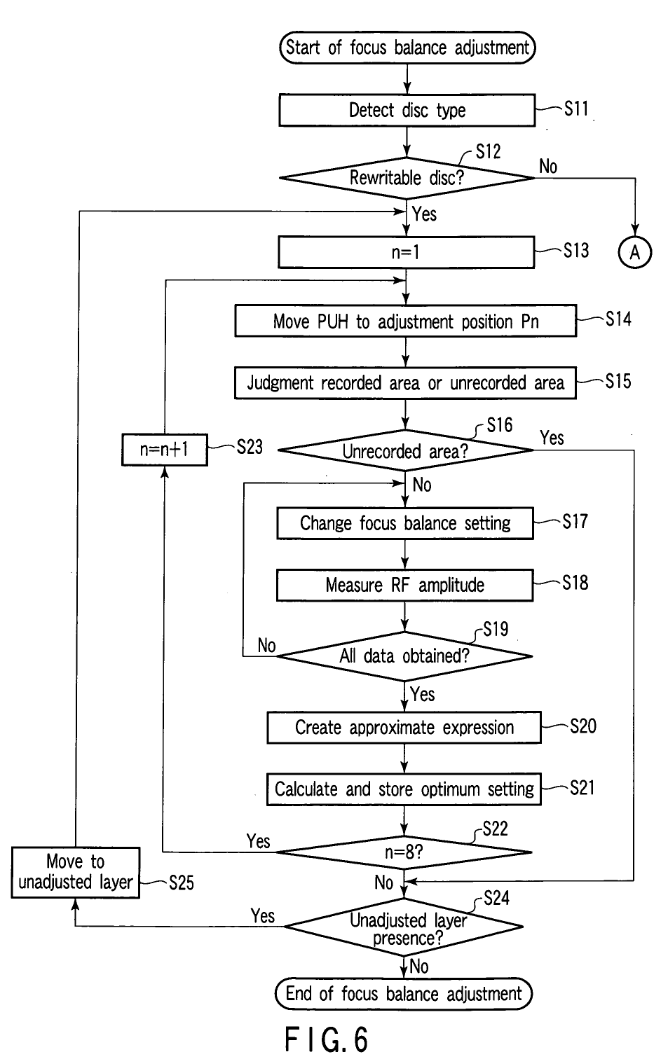

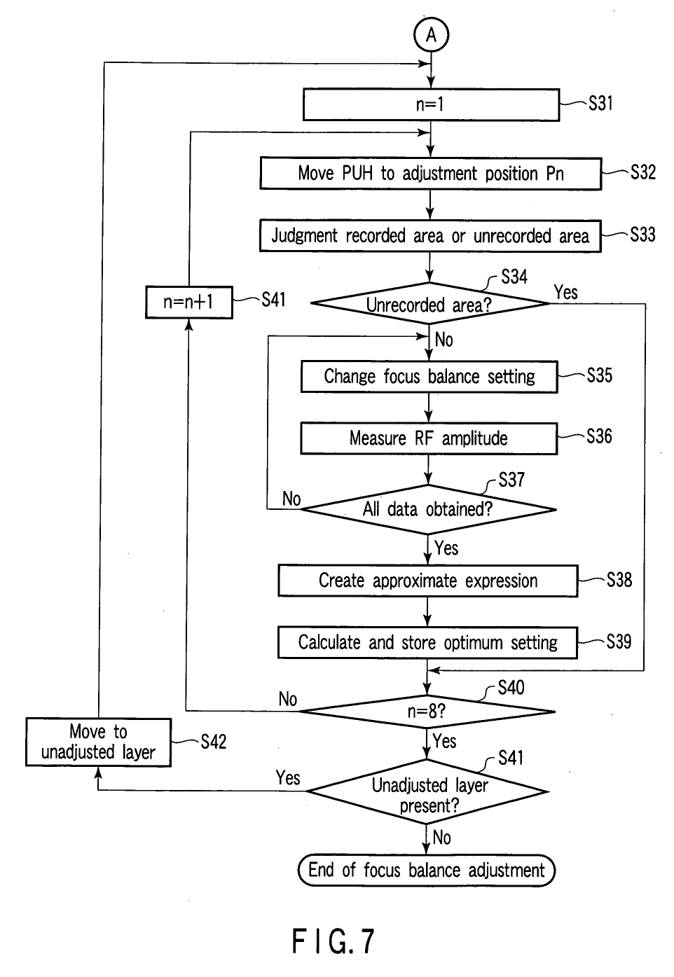

Next, the detection of focus balance adjustment values will be described with reference to a flowchart shown in FIGS. 6 and 7.

FIGS. 6 and 7 form a flowchart for focus balance adjustment made in reproducing an optical disc. Even with an optical disc, such as HD DVD, which is small in focus offset margin, a high reproduction capability can be ensured in all areas by setting up two or more focus balance adjustment positions in the direction of radius of the disc as shown in FIG. 3 and determining the optimum adjustment value for each of the radial positions. In this embodiment, eight adjustment positions are stored in the adjustment position storage unit 212.

When an optical disc is loaded into the optical disc apparatus, the disc type detection unit 211 detects its type from optical disc information recorded in its read-in area (step S11).

The focus balance adjustment control unit 210 then makes a decision of whether or not the detected disc is a rewritable disc (step S12). In the case of a rewritable disc (Yes in step S12), the focus balance adjustment control unit 210 stores a 1 in the register 210A which stores adjustment positions (step S13). In the description which follows, the value stored in the register 210A is taken to be n.

The focus balance adjustment control unit 210 reads information about adjustment position Pn from the adjustment position storage unit 212 and then instructs the motor control circuit 64 to move the optical pickup head 65 to the adjustment position Pn (step S14). The data recording detection unit 219 decides whether or not data has been recorded in the adjustment position Pn (step S15).

After detection, the focus balance adjustment control unit 210 decides whether or not the adjustment position Pn is on the unrecorded area (step S16). If the decision is that the adjustment position Pn is on the unrecorded area (Yes in step S16) and the disc is a read-only or write-once disc, the focus balance adjustment processing is terminated because no data is recorded beyond the current adjustment position Pn.

If, on the other hand, the decision is that the adjustment position Pn is not on the unrecorded area (No in step S16), the focus balance adjustment control unit 210 instructs the adjustment signal output unit 217 to change the gain of the amplifiers 201 and 202, thereby changing the adjustment signal (step S17). Even if No in step S16, when the duty ratio is between the thresholds d1 and d2 shown in FIG. 5, it is desirable to make the same measurements in the inside positions and move the pickup head 56 to the area which has already been recorded with certainty (area where the duty ratio is more than d1). The RF amplitude detection circuit 100 measures the amplitude of the RF signal and the average calculation unit 213 calculates the amplitude average value from the measured values while the optical disc makes one rotation (step S18).

After measurements, the focus balance adjustment control unit 210 makes a decision of whether or not the required number of average values has been obtained (step S19). If No in step S19, a return is made to step S17 to change the focus balance setting and measure the RF amplitude.

If Yes in step S19, the approximate expression creation unit 214 creates an approximate expression indicating the RF amplitude versus focus balance value relationship (step S20). The optimum value calculation unit 215 determines from the resulting approximate expression the focus balance value at which the RF amplitude is maximum. The focus balance adjustment control unit 210 stores the resulting focus balance value for the adjustment position Pn in the register 210A (step S21).

Next, the focus balance adjustment control unit 210 makes a decision of whether or not the value stored in the register 210A is eight (step S22). If not eight (No in step S22), the focus balance adjustment control unit 210 increments the value, n, in the register 210A by one (n=n+1) (in step S23), then moves the optical pickup head 65 to the next adjustment position Pn and performs the processes following step S14.

If, on the other hand, the register value is eight (Yes in step S22), then the focus balance adjustment control unit 210 makes a decision of whether or not there are layers which have not been subjected to focus balance adjustment (step S24). If there is an unadjusted layer or layers (Yes in step S24), then the focus balance adjustment control unit 210 causes the focal point of the light beam to make a jump to an adjusted layer (step S25) and performs the processes following step S13 to determine the optimum focus balance setting for each of the adjustment positions. If the decision is that there is no unadjusted layer (No in step S24), the focus balance adjustment control unit 210 terminates the focus balance adjustment.

A description is given of the case where the decision in step S12 is that the optical disc is not a read-only disc. The write-once disc and the recordable disc, which are not the read-only disc, differ from the read-only disc in that there are unrecorded areas in the middle of the disc. The write-once disc has a standard called RESERVE. Recording may be started after an unrecorded area has been secured in the write-once disc. With the recordable disc, data can be erased. Therefore, where adjustment values are not for the recorded area, it may become necessary to cause the optical pickup head 65 to move to the next adjustment position to adjust the focus balance.

If the decision is that the optical disc is not a rewritable disc (No in step S12), a 1 is stored in the register 210A to store a value indicating the adjustment position (step S31 in FIG. 7).

The optical pickup head 65 is moved to the focus balance adjustment position Pn (step S32). As in step S15, a decision is made as to whether or not data has been written in the adjustment position Pn on the optical disc (step S33).

The focus balance adjustment control unit 210 makes a decision of whether or not the adjustment position is in the unrecorded area (step S34). If Yes in step S34, the procedure goes to step S40. If No in step S34, the focus balance adjustment control unit 210 changes the focus balance setting by changing the gain of the amplifiers 201 and 202 (step S35). The RF amplitude detection circuit 100 measures the RF amplitude (step S36). After the measurement, the focus balance adjustment control unit 210 makes a decision of whether or not the required number of data has been obtained (step S37). If No in step S37, a return is made to step S35 to change the focus balance setting and measure the RF amplitude.

If the decision in step S37 is that the required number of data has been obtained, the approximate expression creation unit 214 creates an approximate expression indicating the RF amplitude versus the focus balance value relationship. The optimum value calculation unit 215 determines from the approximate expression the focus balance value at which the RF amplitude is maximized. The focus balance adjustment control unit 210 stores the resulting focus balance value for the adjustment position Pn in the ROM (step S39).

The optimum value calculation unit 215 makes a decision of whether or not the value, n, stored in the register 210A is eight (step S40). If No in step S40, the focus balance adjustment control unit 210 increments the value n in the register 210A by one (n=n+1) (step S41) and moves the optical pickup head 65 to the next adjustment position Pn to repeat the processes following step S32.

If Yes in step S40, the focus balance adjustment control unit 210 makes a decision of whether or not there is any layer which has not been subjected to focus balance adjustment (step S41). In the presence of an unadjusted layer (Yes in step S41), the focus balance adjustment control unit 210 causes the focal point of the light beam to make a jump to that layer (step S42). The processes following step S31 are repeated to calculate the optimum focus balance setting for each of the adjustment positions. If there is no unadjusted layer (No in step S41), the focus balance adjustment control unit 210 terminates the focus balance adjustment.

The results of adjustment are reflected in seek and read operations according to an object address. For example, when the object address lies between the adjustment positions Pn-1 and Pn, the result of adjustment in the adjustment position Pn is used.

Recording on Unrecorded Disk of Recordable Type

Next, a description is given of focus balance adjustment in recording on a recordable disc, such as HD DVD-R. When the recordable disc is completely unrecorded, focus balance adjustment cannot be made due to the absence of an RF signal.

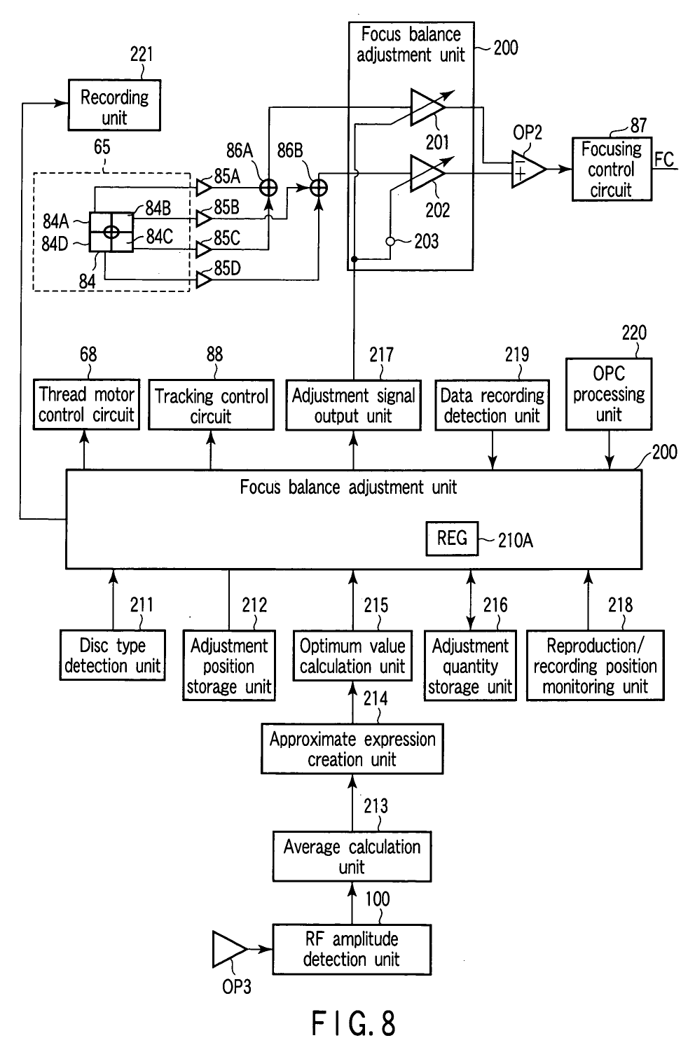

Reference is next made to FIG. 8 to describe a configuration which, in recording data on an unrecorded disc of recordable type, measures the RF amplitude and determines the optimum quantities of focus balance adjustment from the measured RF amplitude values.

As shown in FIG. 8, this configuration includes a disc type detection unit 211, an adjustment position storage unit 212, an average calculation unit 213, an approximate expression creation unit 214, an optimum value calculation unit 215, an adjustment quantity storage unit 216, an adjustment signal output unit 217, a reproduction/recording position monitoring unit 218, a data recording detection unit 219, an OPC processing unit 220, and a recording unit 221.

The disc type detection unit 211, the adjustment position storage unit 212, the average calculation unit 213, the approximate creation unit 214, the optimum value calculation unit 215, the adjustment quantity storage unit 216, the adjustment signal output unit 217, the reproduction/recording position monitoring unit 218, and the data recording detection unit 219 are the same as those described with reference to FIG. 4 and hence descriptions thereof are omitted here.

The optimum power control (OPC) processing unit 220 records test data on a power calibration area (PCA) of the optical disc prior to recording data on its recording area to determine the optimum power of the light beam. The recording unit 221 then records data on the recording area of the optical disc.

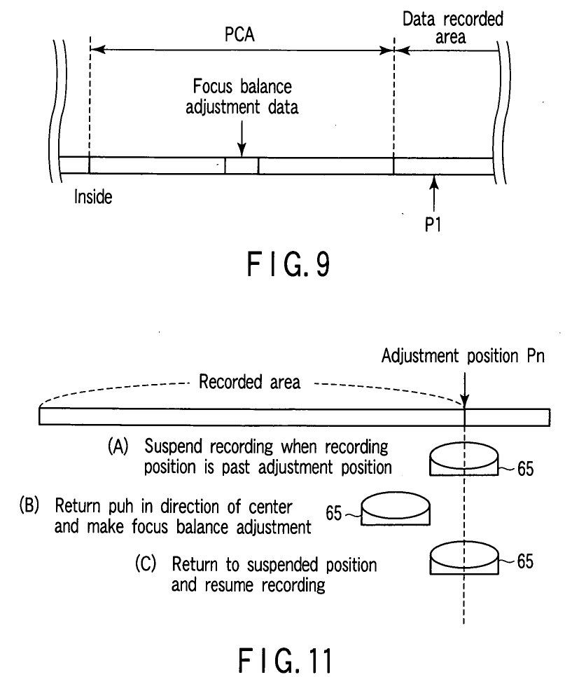

In this embodiment, prior to recording data on the recording area of the disc, focus balance adjustment data are recorded on the PCA of the optical disc (FIG. 9) and the optimum focus balance adjustment values are determined using the focus balance adjustment data.

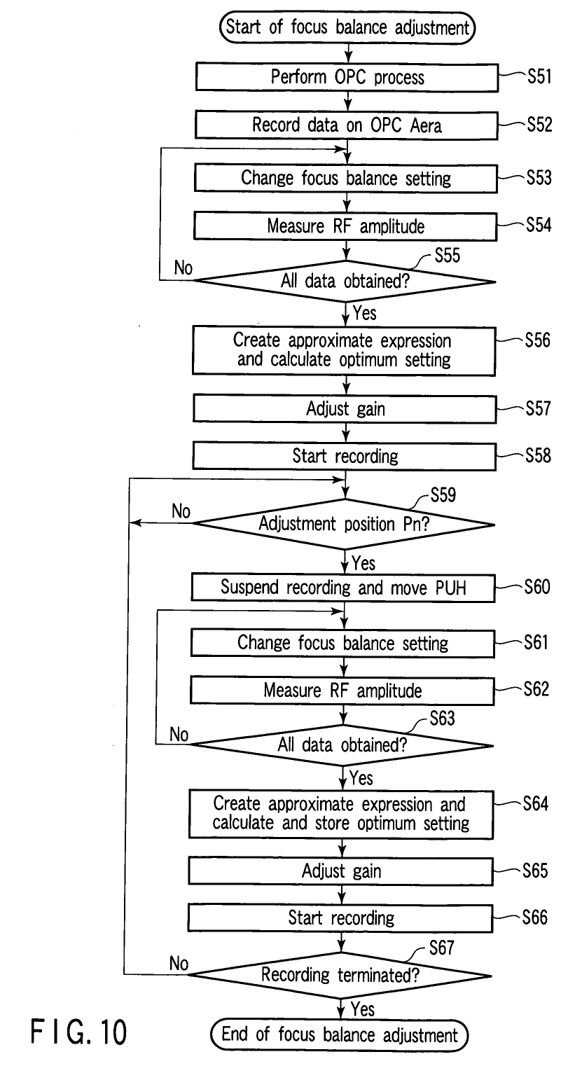

Reference is made to FIG. 10 to describe the procedure for recording data on an unrecorded optical disc while adjusting the focus balance.

First, the OPC processing unit 220 writes power adjustment data in the PCA of the optical disc, then reproduces the data and adjusts the light beam power on the basis of the reproduced data (step S51). The focus balance adjustment control unit 210 records focus balance adjustment data in an area adjacent to the area used for OPC within the PCA through the use of the recording unit 221 (step S52). Since there is a limit the PCA, it is recommended that the focus balance adjustment area be set to a little more than one track in width. After data recording, the focus balance adjustment is made.

As in step S17, the focus balance adjustment control unit 210 changes the focus balance setting by changing the gain of the amplifiers 201 and 202 (step S53). The RF amplitude detection circuit 100 measures the RF signal amplitude and the average calculation unit 213 determines from the measured RF amplitude values the average value of the RF amplitude during one rotation of the optical disc (step S54). As described above, the focus balance adjustment area is a little more than one track in width; therefore, it is required to make the RF amplitude measurement in the tack on state.

After the measurement, the focus balance adjustment control unit 210 makes a decision of whether or not the required number of data has been obtained (step S55). If No in step S55, a return is made to step S53 to change the focus balance setting, measure the RF amplitude, and determines the average value.

If the decision is that the required number of data has been obtained (Yes in step S55), then the approximate expression creation unit 214 creates an approximate expression indicating the RF amplitude value versus focus balance value relationship, and the optimum value calculation unit 215 determines the focus balance value at which the RF amplitude is maximized from the approximate expression and stores it in the ROM as in the case of steps S20 and S21 (step S56). In step S56, the focus balance adjustment unit adjusts the amplifier gain using the focus balance value thus determined (step S57).

After the focus balance adjustment in the PCA, the focus balance adjustment control unit 210 allows the recording unit 221 to start to record data (step S58). At the time of recording, the reproduction/recording position monitoring unit 218 monitors the recording position and makes a decision of whether or not the recording position is the focus balance adjustment position Pn stored in the adjustment position storage unit 212 (step S59). If the decision is that the recording position is the adjustment position Pn (Yes in step S59, see FIG. 11[A]), the focus balance adjustment control unit 210 causes the recording unit 221 to suspend the recording of data (step S60). The focus balance adjustment control unit 210 then causes the thread motor control circuit 68 to slightly move the optical pickup head 65 in the direction of the recorded area (in the direction of center of the disc) from the recording suspended position (see FIG. 11[B]). The focus balance adjustment is then made. The focus balance adjustment here needs to be performed in the recorded area with certainty, which involves moving the optical pickup head 65.

As in step S17, the focus balance adjustment control unit 210 changes the focus balance setting and changes the gain of the amplifiers 201 and 202 (step S61). The RF amplitude detection circuit 100 measures the RF signal amplitude and the average calculation unit 212 determines from the measured values the average value of the RF amplitude while the optical disc makes one rotation (step S62).

After the measurement, the focus balance adjustment control unit 210 makes a decision of whether or not the required number of data has been obtained (step S63). If No in step S63, a return is made to step S61 to change the focus balance setting and measure the RF amplitude.

If the decision is that the required number of data has been obtained (Yes in step S63), then the approximate expression creation unit 214 creates an approximate expression indicating the RF amplitude versus focus balance value relationship, and the optimum value calculation unit 215 calculates the focus balance value at which the RF amplitude is maximized from the approximate expression and stores it in the ROM as in the case of steps S20 and S21 (step S64). The focus balance adjustment unit adjusts the gain of the amplifiers 201 and 202 using the focus balance value obtained in step S56 (step S65).

After the focus balance adjustment has been made, the focus balance adjustment control unit 210 instructs the recording unit 221 to resume recording (step S66, see FIG. 11[C]).

Until it is decided that the recording has been terminated (Yes in step S67), recording suspension, focus balance adjustment and recording resumption are repeated. When a playback operation is to be performed after the termination of recording, a shift can be made to the playback operation with no need to make readjustment because the focus balance value at which the RF amplitude is maximized in each of the focus balance adjustment positions has been already obtained.

Playback/Record Processing on Recordable Disk

The amplitude of the push-pull signal (hereinafter referred to as the PP amplitude) output from the differential amplifier OP1 is correlated with the address reading performance of a recordable disc. The larger the PP amplitude, the lower the possibility of failure in address reading. If the focus balance value at which the RF amplitude is maximized were displaced from the focus balance value at which the PP amplitude is maximized, the address could not read and the possibility of failure in seek would be increased.

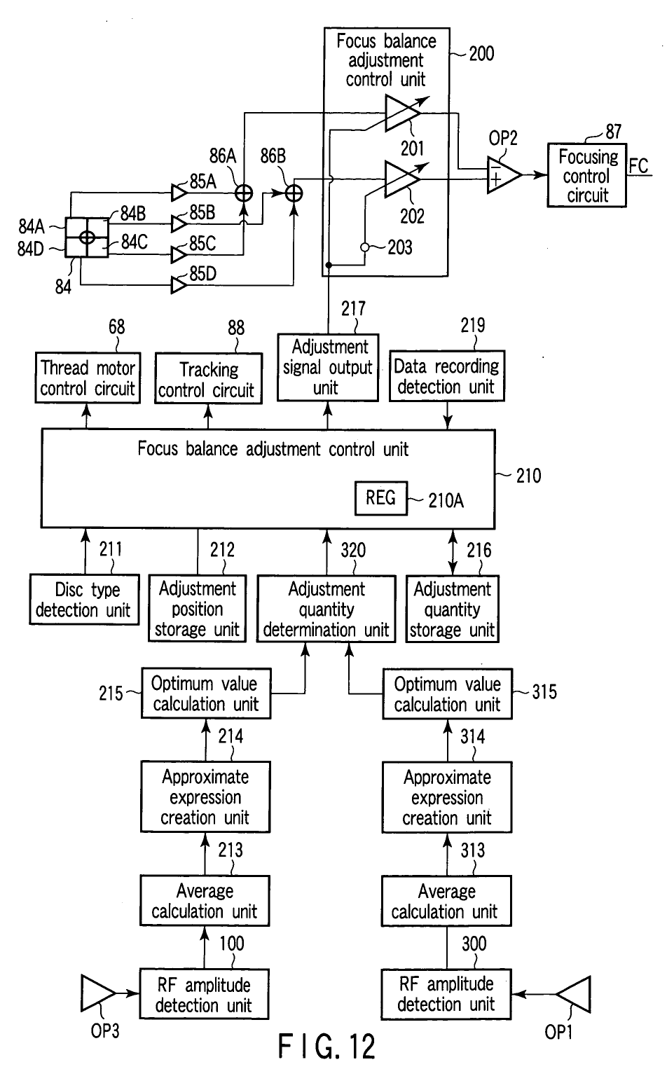

Hereinafter, a description is given of a way to balance the playback/recording performance with the address reading performance. Reference is made to FIG. 12 to describe the configuration for focus balance adjustment at the time of playback of a recordable disc.

As shown in FIG. 12, this configuration includes a disc type detection unit 211, an adjustment position storage unit 212, an average calculation unit 213, an approximate expression creation unit 214, an optimum value calculation unit 215, an adjustment quantity storage unit 216, an adjustment signal output unit 217, a reproduction/recording position monitoring unit 218, a data recording detection unit 219, a PP amplitude detection unit 300, an average calculation unit 313, an approximate expression creation unit 314, an optimum value calculation unit 315, and an adjustment quantity determination unit 320.

The disc type detection unit 211, the adjustment position storage unit 212, the average calculation unit 213, the approximate creation unit 214, the optimum value calculation unit 215, the adjustment quantity storage unit 216, the adjustment signal output unit 217, the reproduction/recording position monitoring unit 218, and the data recording detection unit 219 are the same as those in FIG. 4 and hence descriptions thereof are omitted here.

The PP amplitude detection circuit 300 detects the amplitude of the push-pull signal output from the differential amplifier OP1. The average calculation unit 313 determines the average value of the PP amplitude from the detected values of PP amplitude from the PP amplitude detection circuit 300. The approximate expression creation unit 314 creates an approximate expression indicating the PP amplitude versus focus balance adjustment quantity relationship using the method of least squares. The optimum value calculation unit 315 determines the focus balance quantity at which the PP amplitude is maximized from the approximate expression created by the approximate expression creation unit 314. The adjustment quantity determination unit 320 makes a comparison between the focus balance adjustment quantity at which the RF amplitude is maximized, calculated by the optimum value calculation unit 215, and the focus balance adjustment quantity at which the PP amplitude is maximized, calculated by the optimum value calculation unit 315. When the two adjustment quantities differ, the adjustment quantity determination unit determines a medium quantity between them as the optimum adjustment quantity. A medium value between two adjustment quantities is the average value or weighted average value with one of them weighted.

The method of determining the adjustment quantity is virtually the same as the one described with reference to FIGS. 6 and 7 and only the different points will be described below.

In steps S18 and S36 in which the RF amplitude is measured, the PP amplitude is detected and the average value of the PP amplitude is determined. In steps S20 and S38 in which the approximate expression is created on the basis of the measurements of the RF amplitude, an approximate expression is created on the basis of the measurements of the PP amplitude. In steps S21 and S39 in which the optimum setting is calculated and stored, each of the optimum value calculation units 215 and 315 calculates the optimum adjustment quantity on the basis of a corresponding one of the two approximate expressions. The adjustment quantity determining unit 320 makes a comparison between the two adjustment quantities. When the two adjustment quantities differ, the adjustment quantity determining unit determines a medium adjustment quantity between the two adjustment quantities as the optimum adjustment quantity and stores it in the adjustment quantity storage unit 216. If the two adjustment quantities are equal to each other, the adjustment quantity determining unit 320 stores the adjustment quantity in the adjustment quantity storage unit 2216.

When the focus balance value at which the RF amplitude is maximized is displaced from the focus balance value at which the PP amplitude is maximized, both the playback/recording performance and the address reading performance can be secured by setting a medium value between the two focus balance values as the optimum focus balance value. The same holds true for recording on an unrecorded optical disc and hence a description thereof is omitted.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus having a function of adjusting focus balance, comprising:
a pickup head configured to irradiate a light beam onto an optical disc and receive the light beam reflected from the optical disc to output a detected signal;
a movement unit configured to move the pickup head to two or more adjustment positions;
an amplitude measurement unit configured to measure the amplitude of an RF signal in the detected signal from the pickup head;
an adjustment signal output unit configured to output an adjustment signal;
a focus balance adjustment unit configured to adjust the quantity of focus balance adjustment according to the adjustment signal;
an adjustment signal changing unit configured to instruct the adjustment signal output unit a plurality of times to change the adjustment signal in order to measure the RF signal amplitude for each of a plurality of focus balance quantities in each of the adjustment positions;
a maximum RF amplitude adjustment quantity estimation unit configured to estimate a focus balance adjustment quantity at which the RF signal amplitude is maximized from the focus balance adjustment quantities and the RF signal amplitude measured by the amplitude measurement unit;
a storage unit configured to store the focus balance adjustment quantities at which the RF signal amplitude is maximized each estimated in a respective one of the adjustment positions; and
an adjustment quantity instruction unit configured to, at the time of playback/recording of the optical disc, instruct the adjustment signal output unit to output an adjustment signal for each of the focus balance adjustment quantities stored in the storage unit.

2. The optical disc apparatus according to claim 1, further comprising
a decision unit configured to decide whether or not the RF signal is detected for each of the adjustment positions,
an estimation stopping unit configured to, when the decision is that the RF signal is not detected and the optical disc is either a read-only disc or a write-once disc, stop the estimation of the optimum focus balance adjustment quantity in the adjustment position in which the decision is that the RF signal is not detected and the following adjustment positions,
and a movement instruction unit configured to instruct the movement unit configured to, when the decision is that the RF signal is not detected and the optical disc is a readable/rewritable disc, move the pickup head to the adjustment position next to the adjustment position in which the decision is that the RF signal is not detected.

3. The optical disc apparatus according to claim 1, wherein the measurement of the RF signal amplitude is made in the state where tracking servo is turned off.

4. The optical disc apparatus according to claim 1, wherein the maximum RF amplitude adjustment quantity estimation unit includes an approximate expression creation unit which calculates from the RF signal amplitude measured for each of the focus balance adjustment quantities an approximate expression representing the relationship between the focus balance adjustment quantities and the RF signal amplitude, and an adjustment quantity calculation unit which calculates the focus balance adjustment quantity at which the RF signal amplitude is maximized from the approximate expression.

5. The optical disc apparatus according to claim 1, further comprising a push-pull signal amplitude measurement unit configured to measure the amplitude of an push-pull signal when the optical disc is a recordable disc, a maximum PP amplitude adjustment quantity estimation unit configured to estimate, from a plurality of push-pull signals obtained when the RF signal amplitude is measured for each of the focus balance adjustment quantities, the focus balance adjustment quantity at which the push-pull signal amplitude is maximized, and an adjustment signal instruction unit configured to, when there is a difference between the focus balance adjustment quantity at which the RF signal amplitude is maximized and the focus balance adjustment quantity at which the push-pull signal amplitude is maximized, instruct the adjustment signal output unit to output an adjustment signal corresponding to a medium focus balance adjustment quantity between the two focus balance adjustment quantities.

6. An optical disc apparatus which writes data on an unrecorded optical disc of recordable type, comprising:
a pickup head configured to irradiate the optical disc with a light beam and receive the light beam reflected from the optical disc to output a detected signal;
a movement unit configured to move the light beam irradiated position on the optical disc in the direction of its radius;
an amplitude detection unit configured to detect the amplitude of an RF signal in the detected signal from the pickup head;
an adjustment position movement unit configured to move the pickup head to a plurality of adjustment positions;
a recording unit configured to record focus balance adjustment data in a power calibration area of the optical disc;
an adjustment signal output unit configured to output an adjustment signal;
a focus balance adjustment unit configured to adjust the quantity of focus balance adjustment according to the adjustment signal;
a first adjustment signal changing instruction unit configured to instruct the adjustment signal output unit every time the focus balance adjustment data is reproduced to change the adjustment signal in order to reproduce the focus balance adjustment data with each of a plurality of focus balance quantities;
a first adjustment quantity estimation unit configured to estimate the optimum focus balance adjustment quantity from the RF signal amplitude detected for each of the focus balance adjustment quantities;
a first output instruction unit configured to instruct the adjustment signal output unit to output an adjustment signal corresponding to the estimated focus balance adjustment quantity;
a recording unit to record data on the optical disc;
a storage unit configured to store a plurality of positions;
a suspension instruction unit configured to instruct the recording unit to suspend data recording when the position being recorded by the recording unit coincides with a position stored in the storage unit;
a movement instruction unit configured to instruct the movement unit to move the pickup head so that the light beam is directed onto an recorded area;
a second adjustment signal change instruction unit configured to instruct the adjustment signal output unit a plurality of times to change the adjustment signal in order to measure the RF signal amplitude for each of the focus balance quantities in a state where the light beam is directed onto the recorded area;
a second adjustment quantity estimation unit configured to estimate the new optimum focus balance adjustment quantity from the RF signal amplitude measured for each of the focus balance adjustment quantities obtained in the state where the light beam is being directed onto the recorded area;
a second output instruction unit configured to instruct the adjustment signal output unit to output an adjustment signal corresponding to the estimated new focus balance adjustment quantity; and
a resumption instruction unit configured to instruct the recording unit to resume data recording in a state where the focus balance adjustment unit adjusts focus balance with the new focus balance adjustment quantity.

7. The optical disc apparatus according to claim 6, wherein, in measuring the RF signal amplitude for each of the focus balance adjustment quantities in the state where the light beam is being directed onto the recorded area, the measurement of the RF signal amplitude is made in a state where tracking servo is turned off.

8. The optical disc apparatus according to claim 6, wherein the first adjustment quantity estimation unit includes an approximate expression creation unit which calculates from the RF signal amplitude measured for each of the focus balance adjustment quantities an approximate expression representing the relationship between the focus balance adjustment quantities and the RF signal amplitude, and an adjustment quantity calculation unit which calculates the focus balance adjustment quantity at which the RF signal amplitude is maximized.

9. The optical disc apparatus according to claim 6, further comprising a push-pull signal amplitude measurement unit configured to measure the amplitude of an push-pull signal when the optical disc is a recordable disc, a maximum PP amplitude adjustment quantity estimation unit configured to estimate, from a plurality of push-pull signals obtained when the RF signal amplitude is measured for each of the focus balance adjustment quantities, the focus balance adjustment quantity at which the push-pull signal amplitude is maximized, and a third output instruction unit configured to, when there is a difference between the focus balance adjustment quantity at which the RF signal amplitude is maximized and the focus balance adjustment quantity at which the push-pull signal amplitude is maximized, instruct the adjustment signal output unit to output an adjustment signal corresponding to a medium focus balance adjustment quantity between the two focus balance adjustment quantities.

10. A control method for use with an optical disc having a function of adjusting focus balance, comprising:
moving a pickup head to an adjustment position;
adjusting the quantity of adjustment of focus balance;
measuring the amplitude of an RF signal in the adjustment position;
adjusting the focus balance adjustment quantity and measuring the RG signal amplitude a plurality of times;
estimating the focus balance adjustment quantity at which the RF signal amplitude is maximized from the measured focus balance adjustment quantities and RF signal amplitude;
moving the pickup head to a different adjustment position;
estimating the focus balance adjustment quantity at which the RF signal amplitude is maximized in the different adjustment position by adjusting the focus balance adjustment quantity and measuring the RF signal amplitude a plurality of times; and
adjusting the focus balance adjustment quantity to the focus balance adjustment quantity estimated in the different adjustment position.

11. The method according to claim 10, further comprising deciding whether or not the RF signal is detected after the pickup head has been moved to the adjustment position, stopping, when the decision is that the RF signal is not detected and the optical disc is either a read-only disc or a write-once disc, the estimation of the optimum focus balance adjustment quantity in the adjustment position in which the decision is that the RF signal is not detected and the following adjustment positions, and, when the decision is that the RF signal is not detected and the optical disc is a readable/rewritable disc, moving the pickup head to the adjustment position next to the adjustment position in which the decision is that the RF signal is not detected.

12. The method according to claim 10, wherein the measurement of the RF signal amplitude is made in the state where tracking servo is turned off.

13. The method according to claim 10, wherein the step of estimating the focus balance adjustment quantity at which the RF signal amplitude is maximized involves creating from the RF signal amplitude measured for each of the focus balance adjustment quantities an approximate expression representing the relationship between the focus balance adjustment quantities and the RF signal amplitude, and calculating the focus balance adjustment quantity at which the RF signal amplitude is maximized from the approximate expression.

14. The method according to claim 10, further comprising measuring the amplitude of an push-pull signal at the time of measurement of the RF signal amplitude when the optical disc is a recordable disc, estimating, from the focus balance adjustment quantities and the push-pull signal amplitude, the focus balance adjustment quantity at which the push-pull signal amplitude is maximized, and, when there is a difference between the focus balance adjustment quantity at which the RF signal amplitude is maximized and the focus balance adjustment quantity at which the push-pull signal amplitude is maximized, adjusting the focus balance adjustment quantity to a medium value between the two focus balance adjustment quantities.

15. A control method for use with an optical disc apparatus which records data on an unrecorded optical disc of recordable type, comprising:
recording adjustment data in a power calibration area of the optical disc:
adjusting the quantity of adjustment of focus balance;
measuring the amplitude of an RF signal by reproducing the adjustment data in the adjustment position;
adjusting the focus balance adjustment quantity and measuring the RF signal amplitude a plurality of times;
estimating the focus balance adjustment quantity at which the RF signal amplitude is maximized from the focus balance adjustment quantities and RF signal amplitude;
adjusting the focus balance adjustment quantity to the estimated focus balance adjustment quantity;
starting to record data on the optical disc;
suspending the data recording when the data recording position is a set value;
moving a pickup head so that a light beam is directed onto a recorded area;
adjusting the focus balance adjustment quantity in the state where the light beam is being directed onto the recorded area;
measuring the RF signal amplitude;
adjusting the focus balance adjustment quantity and measuring the RF signal amplitude a plurality of times;
estimating the focus balance adjustment quantity at which the RF signal amplitude is maximized from the focus balance adjustment quantities and RF signal amplitude;
adjusting the focus balance adjustment quantity to the estimated new focus balance adjustment quantity; and
resuming the data recording.

16. The method according to claim 15, wherein, in measuring the RF signal amplitude for each of the focus balance adjustment quantities in the state where the light beam is being directed onto the recorded area, the measurement of the RF signal amplitude is made in a state where tracking servo is turned off.

17. The method according to claim 15, wherein the step of estimating the focus balance adjustment quantity at which the RF signal amplitude is maximized involves creating from the RF signal amplitude and the focus balance adjustment quantities an approximate expression representing the relationship between the focus balance adjustment quantities and the RF signal amplitude, and calculating the focus balance adjustment quantity at which the RF signal amplitude is maximized from the approximate expression.

18. The method according to claim 15, further comprising measuring the amplitude of an push-pull signal at the time of measurement of the RF signal amplitude when the optical disc is a recordable disc, estimating, from the focus balance adjustment quantities and the push-pull signal amplitude, the focus balance adjustment quantity at which the push-pull signal amplitude is maximized, and, when there is a difference between the focus balance adjustment quantity at which the RF signal amplitude is maximized and the focus balance adjustment quantity at which the push-pull signal amplitude is maximized, adjusting the focus balance adjustment quantity to a medium value between the two focus balance adjustment quantities.
